(19) United States
(12) Patent Application Publication
(10) Pub. No.: US 2026/0161969 A1
(43) Pub. Date: Jun. 11, 2026

(54) HUMAN READABLE WORLD MODEL GENERATOR FOR KNOWLEDGE MANAGEMENT

(71) Applicant: Oliver Siegel, Laguna Beach, CA (US)

(72) Inventor: Oliver Siegel, Laguna Beach, CA (US)

(21) Appl. No.: 18/977,892

(22) Filed: Dec. 11, 2024

(51) Int. Cl. G06N 5/04

(52) U.S. Cl. CPC G06N 5/04

(57) ABSTRACT

World-models are produced by generating node networks of connected statements, using a question-answering system informed by a semantic ontology of Problem, Goal, and Solution Nodes with connections representing causal relationships. A computer implemented device controls the generation of world-models. Reports and evaluations are created about world-models to infer useful knowledge or improve upon the world-models.

### FIELD OF THE DISCLOSURE

This disclosure relates to a knowledge-management and reasoning system, which is capable of automatically generating and evaluating knowledge via node-network based world-models for problem-solving according to a semantic ontology framework.

### BACKGROUND

Our society faces an increasing number of multifaceted challenges that require innovative and informed solutions. From combating misinformation and navigating information overload to addressing global issues like climate change, public health crises, and economic inequality, the complexity and scale of these problems often exceed human capacity for analysis and resolution.

Automated knowledge-generation systems can play a crucial role by synthesizing vast data sets, uncovering actionable insights, and supporting decision-making processes in areas such as scientific discovery, engineering innovation, public policy, and organizational strategy. These systems could significantly enhance our ability to tackle pressing real-world problems with greater accuracy, efficiency, and foresight.

Thus, there is a need for a concrete computational and algorithmic implementation of a reasoning framework and a knowledge-management system to automatically create reliable, accurate, and interpretable solutions to complex problems.

The challenges and obstacles to successfully achieving this lie in three key areas:
1) Converting abstract problem-solving frameworks and semantic ontologies into actionable algorithms that can be automated and utilized across various disciplines and industries
2) Producing self-consistent, dynamically evolving world-models that integrate diverse data sources into coherent, human-readable knowledge graphs.
3) Extracting insights from these knowledge graphs to inform problem-solving, decision-making, and innovation, while preventing biases, logical fallacies, and still accounting for the evolving nature of knowledge.

The disclosure presented herein addresses these needs and challenges.

### SUMMARY

The approach disclosed herein aims to address inefficiencies in knowledge creation and solutions discovery with an automated system capable of generating a self-consistent, human-readable “world-model” that can self-correct and optimize over time.

The invention disclosed herein comprises a knowledge-management system, a question-asking system, a world-model evaluation system and a symbolic reasoning system based on a semantic ontology framework.

Specifically, the automated system is based on a particular node network architecture, comprised of a specialized semantic ontology and a database system to store propositions or statements and their relationships. Using a node connection populator subroutine, the node network is automatically populated and connected into a world-model with data sourced from uniquely configured LLMs trained on publicly available, crowdsourced data. After the world-model has reached a desired size, it is automatically evaluated for problems. The report generated by this evaluation process is then used to seed a new world model, which extends the previous one and improves upon it, or builds a new world model altogether.

The world-model evaluation system, the knowledge-management system, and the symbolic reasoning system all leverage a question-asking system capable of generating useful questions, and a node connection populator subroutine, which leverages a statement parser to automatically create Problem, Goal, or Solution Descriptors that constitute the answer to the generated question. This automated generation of knowledge according to the semantic ontology framework can support users in addressing a number of multifaceted challenges.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows a schematic illustration how chatbots powered by Large Language Models work.

FIG. 2 shows a broad overview of a knowledge management system based on a semantic ontology framework.

FIG. 3 shows how a knowledge management system integrates with Large Language Models.

FIG. 4 shows a user interface to configure the initial parameters of a world-model, and a screen of an automated world-model creation process in progress.

FIG. 5 shows a user interface to review a fully generated world-model and the possible actions that follow, and a screen of the automatically generated evaluation report of the world-model with further available actions for the user.

FIG. 6 shows the node types and symbols as well as the semantic ontology for connection types between nodes to power an automated reasoning system.

FIG. 7 shows a flow chart of a world-model generator subroutine.

FIG. 8 shows a flow chart of a node connection populator subroutine.

FIG. 9 shows a flow chart of a subroutine to automatically connect statements to other statements based on a question-answering system.

FIG. 10 shows symbolic views of the semantic ontology schema, configuration, and question-asking and evaluation process based on node connection types.

FIG. 11 shows an example of a fully connected node and an example diagram of a completed world model.

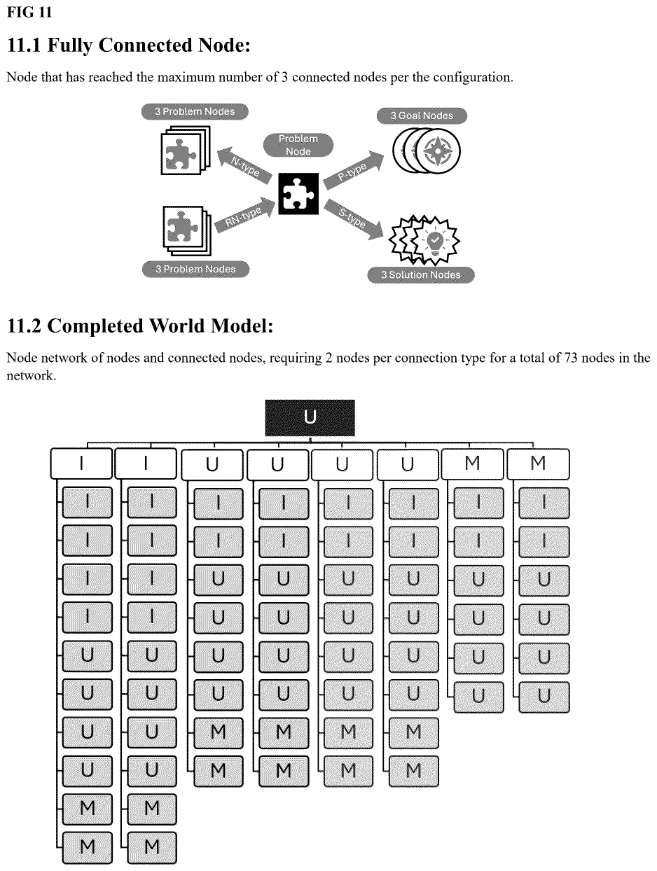

FIG. 12 shows an example of a fully connected node with example contents of connected nodes displayed on a tablet computer.

FIG. 13 shows a knowledge management system, a symbolic reasoning system, a question asking system, and a world model evaluator system.

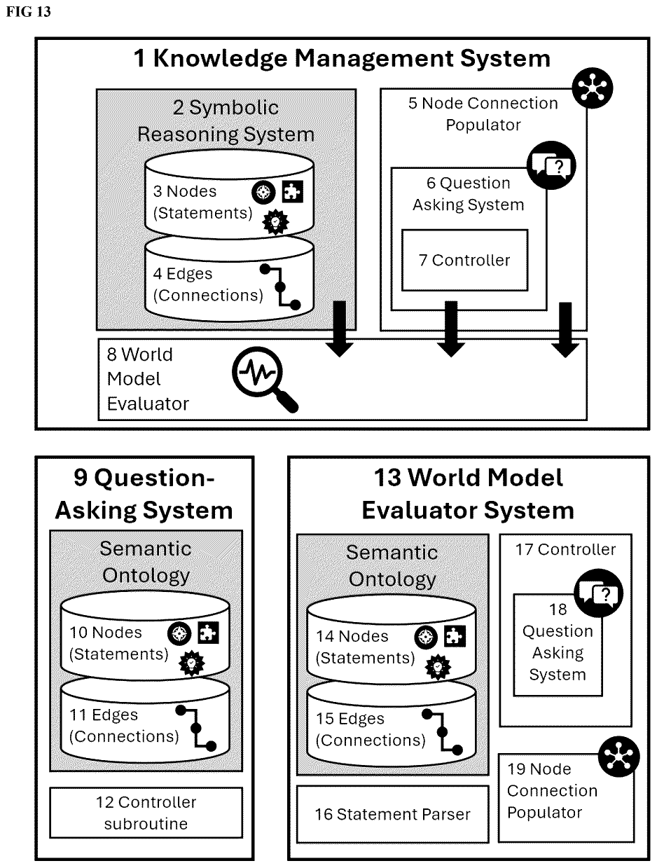

### DETAILED DESCRIPTION

### State of the Art: Large Language Models

Large Language Models (LLMs) are a breakthrough innovation in artificial intelligence that allow computers to process natural language at human-level proficiency.

While the invention disclosed herein heavily relies on large language models, it constitutes a knowledge-management technology distinct from LLMs. To clarify the differences, a brief overview of the functionality, utility, and limitations of LLMs will be provided.

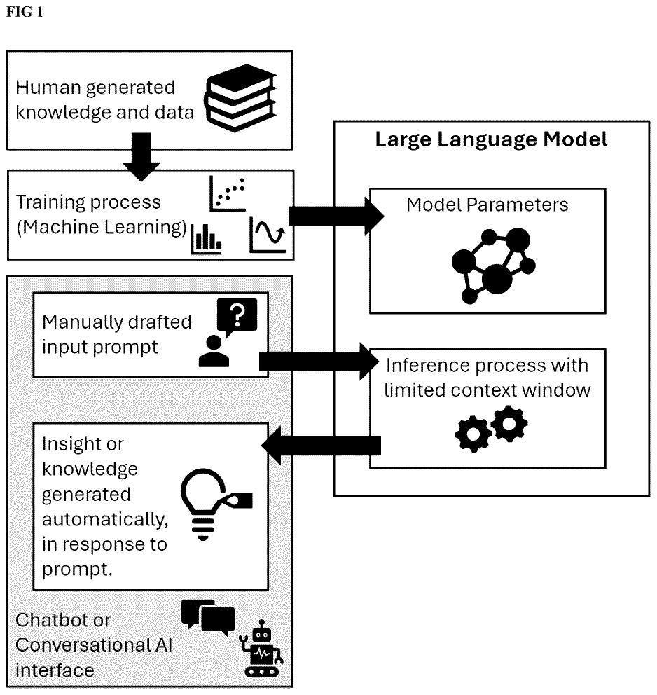

FIG. 1 shows that human generated knowledge and data can be used to train LLMs with a machine learning process. This process is used to teach the LLM patterns, relationships, and structures in the human generated training data. The training process requires lots of computational power, hardware, and energy, but it will produce powerful “parameters”, which can be thought of as the “brain” of the LLM.

Ideally, LLMs would have a transparent, human-readable “brain” to store and retrieve facts. Currently, their black-box architecture allows them to articulate facts as an emergent behavior but prevents direct programming or verification of their internal knowledge.

Despite this limitation, LLMs have been proven effective in interpreting, manipulating, and producing human readable text-documents at human-level proficiency, thus they are capable of automating knowledge work at unprecedented levels, as long as the controllers that instruct such LLMs are properly constructed. Instructing LLMs to complete certain tasks is known as prompt engineering.

A common method to extract knowledge from LLMs is via chatbot or conversational AI interfaces, where a human manually drafts a prompt and sends it to the LLM. The LLM then “predicts” a response, based on the parameters of the model, and it will automatically generate an insight or knowledge in response to the given prompt.

LLMs excel at generating human-readable text when prompted correctly, but they face some limitations. On the one hand, LLMs are constrained by limited context windows of the inference process which restricts the amount of text they can process at once.

On the other hand, LLMs sometimes hallucinate, producing inaccurate information. After all, it is difficult to discern the difference between an insight (meaning new, previously unarticulated knowledge that is useful) and a hallucination (a falschood that sounds plausible but doesn't hold up under scrutiny).

Attempts to address these issues include chain-of-reasoning models, where LLMs collaborate to generate knowledge-essentially two LLMs prompting each other. However, these efforts sometimes fall short due to a lack of structured mechanisms to ensure coherence, reliability, and interpretability. As a result, outputs are sometimes fragmented, biased, or hallucinated, failing to self-correct or adapt to evolving evidence. For example, as new real-world events occur which were not present in the initial training data, the LLM will have no knowledge of these facts and thus can't produce knowledge related to recent world events. This necessitates integrating LLMs into larger, structured knowledge management systems.

LLMs are constantly improving, although usually by sheer brute force, which involves increasing the amounts and quality of training data, number of parameters, and growing the hardware and electricity invested into training. However, it is currently unclear what the limits of these approaches are. Will LLMs with a sufficient number of parameters become more intelligent and infer the rules of creativity and reasoning from their training data, and thus be capable of discovering novel physics? Even if current LLMs somehow had discovered these solutions in their training data and had access to them, a skilled prompt engineer would still need to figure out how to extract these insights efficiently.

In summary, although LLMs are incredibly useful tools and give computers new, powerful abilities, their utility is obstructed by several factors, such as the quality and recency of training data, limited context windows, hallucinations, the need for manual prompting, and energy expensive training processes that produce static parameters.

### Detailed Terminology and Inventive Concepts

When there is development in a technical discipline, there can sometimes be a lack of consensus on terminology. Consequently, it may be difficult for novices or outsiders to navigate a domain, or their approach may be misunderstood due to incongruent labels and a lack of shared vocabulary. The following paragraphs aim to clarify commonly used terms that relate to the invention described herein.

In mathematics, data-science, and computer engineering various labels can describe blueprints or frameworks for software architecture and artificial intelligence systems. In the context of these frameworks, node networks are virtual graphs that consist of points or “knots” which are connected via “edges”. Depending on the use, these nodes could represent documents, statements, propositions, numbers, formulas, or other files containing data or primitive information. Sometimes, the edges that connect nodes are called vectors, especially if they have a designated direction.

Node networks and vector graphs can be stored in lists, tables, spreadsheets, arrays, or databases, sometimes referred to as a matrix. When storing directed edges of a node network or vector graph, the directed edges and connections can be represented and stored via hierarchical parent/child relationships.

A framework, architecture, or schema for how to construct a particular node network according to a structured blueprint may be called a semantic ontology. A node network that represents knowledge defined by a semantic ontology might be called a knowledge graph. It shall be noted that the contents that populate a knowledge graph with information are distinct from the schema, framework, or architecture that dictate the structure and shape of a knowledge graph. In this context, it is possible to use large bodies of text-based descriptions and convert paragraphs of text into a multi-dimensional knowledge graph. Changes in the schema or framework for how to parse text into a graph will lead to changes in the resulting graph.

Many advances have been made in this field since the inception of the world wide web, which itself is essentially a crowdsourced, unstructured knowledge graph with directed edges known as “links”. Machine learning techniques, Natural Language Processing (NLP), and deep neural networks are used to create various types of graphs and graph schemas, often in an automated and unsupervised fashion. These node graphs and neural networks have been proven extremely useful to draw inferences, make predictions, and even create Large Language Models (LLMs) for automated text generation, often labeled as AI.

Despite these advances, one concern is that the rules, schemas, or graphs that machine learning techniques produce are often abstract and not immediately explainable or human readable. Some researchers and philosophers consider this an existential risk.

Delving deeper into fields related to NLP and the invention described herein, we encounter semantics, linguistics, and philosophy of mind. Consequently, the following labels and terms play a role for the invention, as they are commonly used to express semantic and linguistic content or context:

Propositions are declarative sentences. The content of these propositions, or their meaning, is often evaluated to be either true or false. A statement on the other hand is a concrete linguistic or symbolic expression that conveys a proposition. Statements can be made in various languages, and there are various ways to categorize different types of statements. For example:

Descriptive statements aim to describe facts or states of affairs. Normative or prescriptive statements declare how things ought to be. Attitudinal statements express a speaker's feelings, beliefs, or attitudes towards a specific proposition.

Although abstract, these terms and axioms often inform the practical, concrete, and tangible implementation of technologies, such as computer programming languages and algorithms. Consequently, these concepts often inform the construction of symbolic reasoning procedures and AI systems.

Finally, at the intersection of all these fields, we arrive at world models.

World models are descriptions, approximations, or maps of reality to help perceive, conceive, reason, navigate, orient, solve problems, or make decisions. Some world models can be expressed as knowledge graphs because they represent points of knowledge about the world, and they encode the relationships between these points of knowledge. Abstract, graph-based world models can also be converted into human-readable, text-based descriptions, statements, or narratives that represent a part of or the entire world model. And vice versa, just like schema-based knowledge graphs can be generated from large bodies of text, world models can also be created in the same manner, using text as their source.

Due to their ability to interpret, manipulate, and produce text-documents, LLMs can be effective in parsing text-based descriptions into graph-based world models in an automated fashion, provided the prompts and controllers have been engineered effectively to allow for a meaningful categorization of knowledge.

Ultimately, the purpose of these knowledge management and knowledge creation methods is to solve complex problems faster and make better decisions more easily.

However, problem-solving is typically viewed as context-dependent and domain-specific, suggesting that no universal approach exists for categorizing, defining, or solving problems across disciplines.

Although problem-solving methodologies—such as mental contrasting, root cause analysis, theory of constraints, problem decomposition, and strategic planning—have existed for a while, there is a lack of unifying frameworks that can be used for any problem across all domains. To the contrary, “wicked problems” is a term that has been coined for problems that are too complex to manage.

It must be noted that problem-solving and question-asking are two related, but nuanced concepts. It is often assumed that all questions are problems and that all problems take the shape of a question, but this is not necessarily true. Consider the question “What problem caused the undesirable event?” and the answer to this question will be the description of a problem in the form of a statement.

In addition to that, existing methods often overlook the recursive nature of problem-solving: Even after a problem has been properly defined, analyzed, and one or more possible approaches to solving it were generated, the solutions still have to be implemented. Occasionally, the implementation of a solution can be obstructed by further problems, thus the process of implementing a solution often requires even more problem-solving.

Therefore, it may not be immediately obvious to many that the process of problem-solving is infinitely recursive, and even fractal. This means that every problem can be broken down into smaller problems of the same pattern. Previous attempts to construct General Problem Solvers (GPS) have failed in part due to a problem known as “combinatorial explosion”: a fundamental limitation that demands computational resources beyond the reach of our planet's current technological capabilities, because the parameters to manage the problem became unmanageably large.

A final consideration about problem-solving and decision-making relates to existential purpose and ethics/morality. For some philosophers, the human condition is characterized by both a need to solve practical problems of everyday life, but also to find deeper meaning and spiritual purpose in the pursuit of survival. This can raise questions about the end that necessitates innovations and technological progress: Why solve any problems in the first place? Given that problem-solving never ends, what is considered a good and effective solution? What goals guide or direct our research? What knowledge is truly meaningful, and what is unimportant noise? While broad and vague, these questions are central to many aspects of human activity and life in general.

All this creates a need for a concrete computational and algorithmic implementation of a reasoning framework and a knowledge-management system that bridges subjective human reasoning with objective computational processes, and manages complexity while yielding insights that are actionable, accurate, resilient to biases, and applicable across industries and disciplines.

The invention disclosed herein leverages a specific semantic ontology framework to accomplish a meaningful generation and categorization of knowledge, which effectively amounts to becoming an automated reasoning system.

### Part 1: Knowledge-Management System Overview

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The present description provides a knowledge-management system in which users can configure a device to generate a world-model from an initial proposition or statement and then configure the device to evaluate the generated world-model with the purpose of developing meaningful knowledge about effective solutions to problems.

The present description also provides a reasoning system capable of automatically generating a node-network-based world-model comprised of a specialized semantic ontology from clearly defined connections between normative, attitudinal, prescriptive and/or descriptive statements.

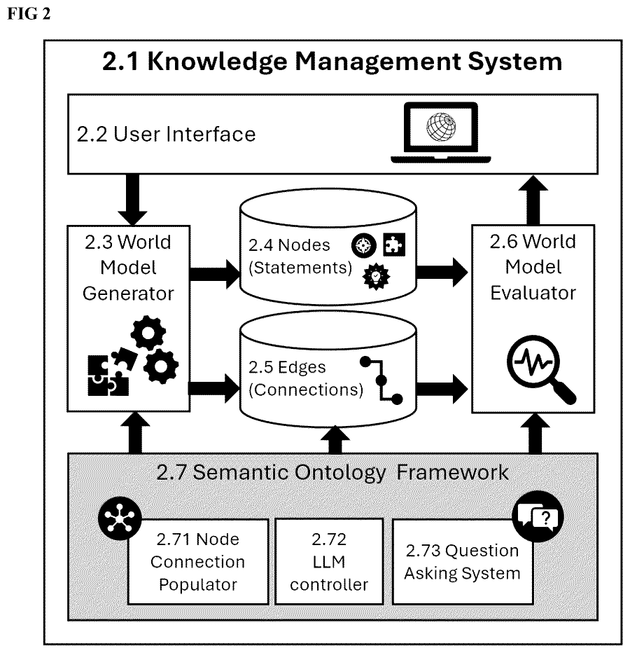

The knowledge-management system comprises a user interface [see FIG. 2.2], a world model generator [2.3] and a world model evaluator [2.6].

The reasoning system uses a collection of specially trained Large Language Models (LLMs) to generate the node network of statements in an unsupervised fashion, while storing statements and connections between statements in a dedicated database [scc FIGS. 2.4 and 2.5].

The world model generation process is automated by a node connection populator [2.71] and a LLM controller [2.72] which leverages a question asking and answering system [2.73] that is informed by a semantic ontology framework [2.7].

The semantic ontology framework [2.7] also dictates the structure, schema, and architecture of the database or storage medium to store nodes and connections [2.4 and 2.5].

The semantic ontology framework [2.7] along with the LLM controlled question asking system [2.72 and 2.73] also inform the world model evaluator [2.6].

The semantic ontology framework [2.7] is foundational to the knowledge-management and reasoning-system disclosed herein.

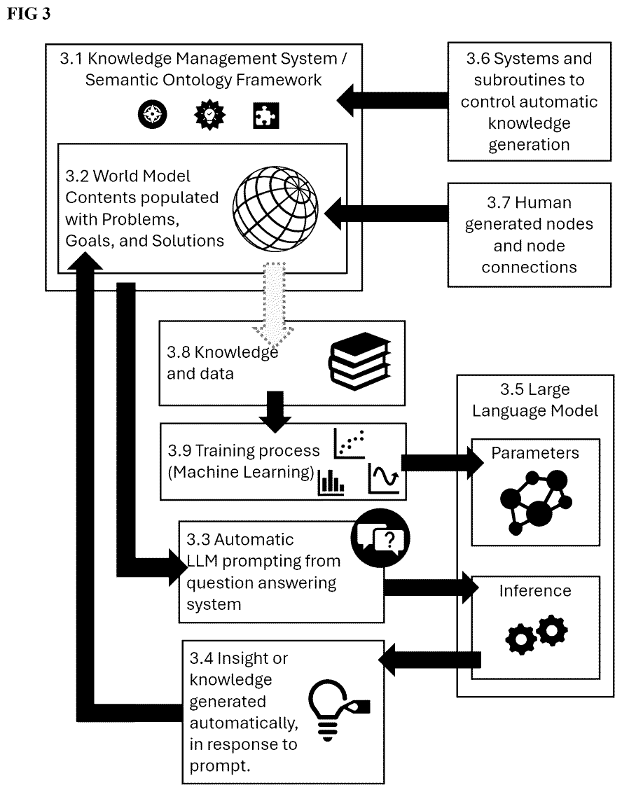

FIG. 3 shows that contents of the knowledge-management system's world models [3.2] are informed by the output [3.4] of a Large Language Model [3.5]. FIG. 3 also shows that a Semantic Ontology [3.1] is responsible for automatically prompting LLMs with questions [3.3], thus creating a feedback loop between the world model and the LLM. Controllers and Subroutines [3.6] are put in place to manage the components of the system to orchestrate and integrate their functionalities. This automatic prompting loop enables users to leverage and prompt LLMs multiple times on a single interaction, thus alleviating the constraints placed on LLMs by small context windows.

The user interface [2.2] also gives users an ability to read, add, edit, or delete nodes and connections from the database [3.7].

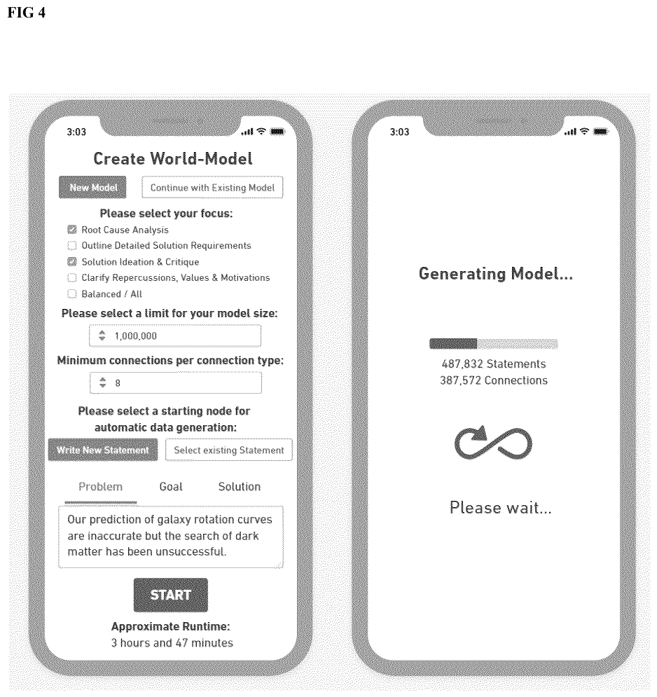

FIG. 4 shows an example interface that allows a user to select initial settings for the creation of their world model, along with a start button to begin the automatic knowledge generation. The screen contains an initial problem-statement which is to be explored. Depending on the size of the desired world-model, knowledge generation may run for some time. This interface can be thought of as an automated research assistant, or strategic consultant that can autonomously run over night and potentially deliver the results that a full-time researcher or consultant would otherwise accomplish in a week. Such a device would free up time and cognitive resources from users, and also alleviate the mental and cognitive strain that comes with ruminating about problems, goals, and solutions. Such a system also empowers leaders and small teams of professionals and knowledge workers to get more research done without the need to allocate resources to employ a large team of researchers, thus keeping overhead costs low.

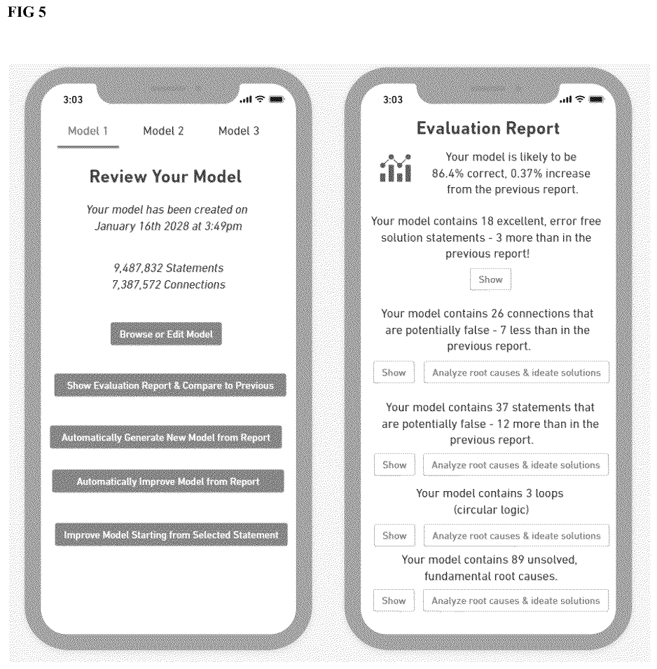

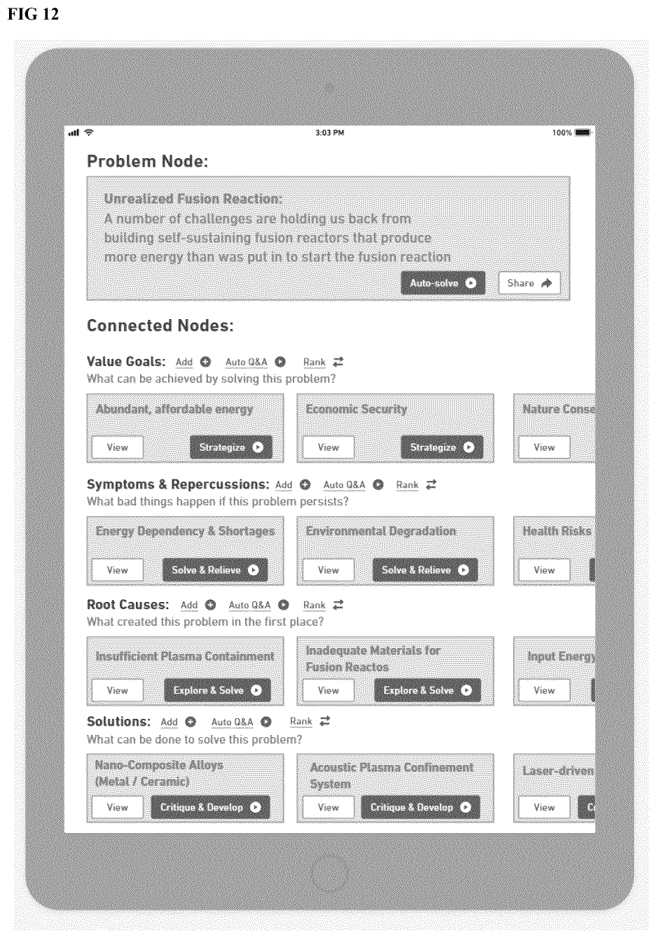

After the automated world model generation process has reached a specified model size, the system will automatically stop the world-model generation and will give the user the option to browse or edit the world-model that was provided, continue improving upon the world-model, or generate an evaluation report of the world-model [see FIG. 5]. An additional display of an example world-model and its contents is explained in Example II [see FIG. 12].

The technological efficiency that the knowledge-management system described herein introduces is largely created by the semantic ontology and the node network that is created. Likewise, the value and utility of the world-model and the evaluation report generated by the knowledge-management system is also created by the semantic ontology.

### Part 2: Semantic Ontology Framework & Reasoning System

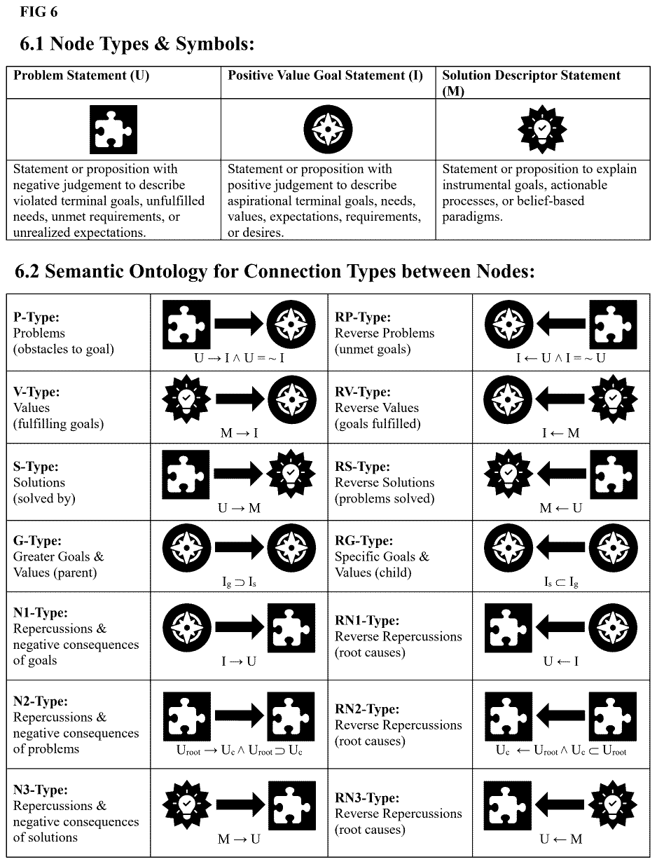

The world-models generated by the knowledge-management system are comprised of a node network that has 3 types of nodes: Problem Nodes (U), Goal Nodes (I), and Solution Nodes (M) [FIG. 6.1].

Each node contains a statement or proposition to describe the contents of the node, which corresponds with a real-world phenomenon, observation, sentiment, object, or experience.

Problem Nodes (U) contain problem descriptors which are descriptive statements with a negative judgement or attitudinal proposition to describe violated terminal goals, unfulfilled needs, unmet requirements, or unrealized expectations.

Goal Nodes (I) contain positive value goal descriptors which are normative or attitudinal statements with positive judgement to describe aspirational and terminal goals, needs, idealistic values, expectations, requirements, or desires.

Solution Nodes (M) contain transformative solution descriptors which are descriptive or prescriptive statements to explain instrumental goals, realistic and actionable processes, methods, or systems, or belief-based paradigms.

Based on these 3 node category types, cause and effect relationships between the nodes can be modeled using further connection category types [FIG. 6.2]. Each connection type can be described with a meaningful label that represents a commonly found cause-and-effect relationship in the goal-problem-solution space (“GPS space”). The semantic ontology that powers the world-model generator and reasoning system is comprised of these connections and their respective descriptors, therefore creating the axioms of truth on which the system operates, and which all world-models generated by the system subsequently adhere to.

These axioms and the node types can be formally expressed with logic symbols and operators, whereas:

I=˜U∧U=˜I

This formula symbolizes that a goal (I) is equal to the opposite of a problem (˜U) and (∧) a problem (U) is equal to the opposite of a goal (˜I).

Further:

M:U→I

And:

M→I⇔⊇U

These formulas symbolize that a solution (M) is defined as a transformative process (→) that turns a problem (U) into a goal (I), and the formulas represent a causal relationship which says if a solution (M) is applied, we achieve (→) a goal (I) which is equivalent (⇔) to eliminating or opposing (˜) the problem (U).

From these basic statements and assumptions, using the vast amount of logic operators that are available to symbolize and formulate such relationships, further symbolic formulas that logically follow could be ideated while staying within the general scope of the semantic ontology to formulate the GPS space.

The computer-based implementation of the reasoning system requires for each stored node to be capable of encoding directed one-to-many connections, meaning that one node can be connected to multiple nodes of another type, and the order in which nodes are connected is also significant and has a “direction”.

For example, a node A may be connected to a node B via connection type C. However, when a node B is connected to a node A, the direction of the connection is reversed (R), thus creating an RC connection—a type C connection in reverse.

The specific connection types [FIG. 6.2] used in the semantic ontology that the system described herein comprises are as follows:

P-Type connections represent problems by showing which obstacles exist to achieve a particular goal. The reversal of this connection creates an RP-Type connection, describing the unmet goals that characterize a problem.

V-Type connections represent values by showing which goals are fulfilled by a particular method or solution. The reversal of this connection creates an RV-Type connection, describing which solutions fulfill a particular goal.

S-Type connections represent solutions by showing which problems are solved by a particular solution. The reversal of this connection creates an RS-Type connection, describing which solutions solve a particular problem.

G-Type connections represent greater goals and values by showing which positive values are more broad, general, or abstract with respect to a particular value. The reversal of this connection creates an RG-Type connection, describing which specific goals and requirements would implement a particular abstract value.

N-Type connections represent repercussions and negative consequences. The reversal of this connection creates an RN-Type connection, describing root causes.

N-Type connections come in 3 distinct instances:

N1-Type connections represent the repercussions and negative consequences of positive value goals. The reversal of this connection creates an RN1-Type connection, describing how problems have positive value goals as their root cause.

N2-Type connections represent the repercussions and negative consequences of problems. The reversal of this connection creates an RN2-Type connection, describing how problems have other problems as their root cause. N2-Type connections are also used to represent the smaller sub-problems that constitute a problem, while RN2-Type connections respectively encode larger super-problems that are comprised of many smaller sub-problems.

N3-Type connections represent the repercussions and negative consequences of solutions. The reversal of this connection creates an RN3-Type connection, describing how problems have solutions as their root cause.

Once again, these connections can be formally expressed with logic symbols and operators, whereas:

Iₛ⊂I_{g}∧I_{g}⊃Iₛ

This formula symbolizes that a smaller, specific goal (Iₛ) is contained within the larger set (⊂) of a greater goals and values (I_{g}) and (∧) that a greater goal or value (I_{g}) is a superset (⊃) containing a smaller, specific goal (Iₛ).

Likewise, we can express that:

Uᵣₒₒₜ→U_{c}∧U_{c}⊂Uᵣₒₒₜ

This formula symbolizes that a root cause problem (Uᵣₒₒₜ) causes (→) a symptom or consequence problem (U_{c}) and (∧) that a symptom or consequence problem (U_{c}) is contained in (⊂) the root cause problem (Uᵣₒₒₜ).

Further, we can express that:

M→I∧M→˜U∧M→U_{c}

This formula symbolizes that a solution (M) leads to the attainment (→) of a goal (I) and (∧) a solution (M) leads to (→) the elimination or opposition (˜) of the problem (U) and (∧) a solution (M) leads to (→) consequence problem or criticism of the solution (U_{c}).

From these basic statements and assumptions, using the vast amount of logic operators that are available to symbolize and formulate such relationships, further symbolic formulas that logically follow could be ideated, while staying within the general scope of the semantic ontology to formulate the GPS space and the hierarchical cause-and-effect relationships that are contained in this space.

While abstract, the patterns, structures, and relationships described in this semantic ontology framework can be seen as a meta-language for problem-solving that is generally applicable to all problems, goals, and solutions and thus has a universal, interdisciplinary appeal that can be leveraged across domains and industries. The semantic ontology framework provides a guideline for what type of knowledge is considered meaningful and important, and also what characterizes a good or effective solution.

It is to be noted that the semantic ontology can represent a recursive process for critical thinking particularly as represented with the N-type connections. Additionally, when two nodes are connected, but the connection does not seem correct (for example one node describes a problem “bad smells” and a N-type consequence node describes “disease”, indicating that bad smells, rather than germs, cause disease) then a problem node can be created that references the connection, and describes why or how the connection may be problematic or incorrect. This extends the semantic ontology's capabilities into what might be called meta-cognition, self-reflection, or reflective reasoning and critical thinking.

Due to the formal and objective articulation of the semantic ontology framework, mathematical and computer-scientific principles can now be applied to further refine the utility of the framework and make it tangible and applicable across domains and industries.

### Part 3: World Model Generator and Question Answering System

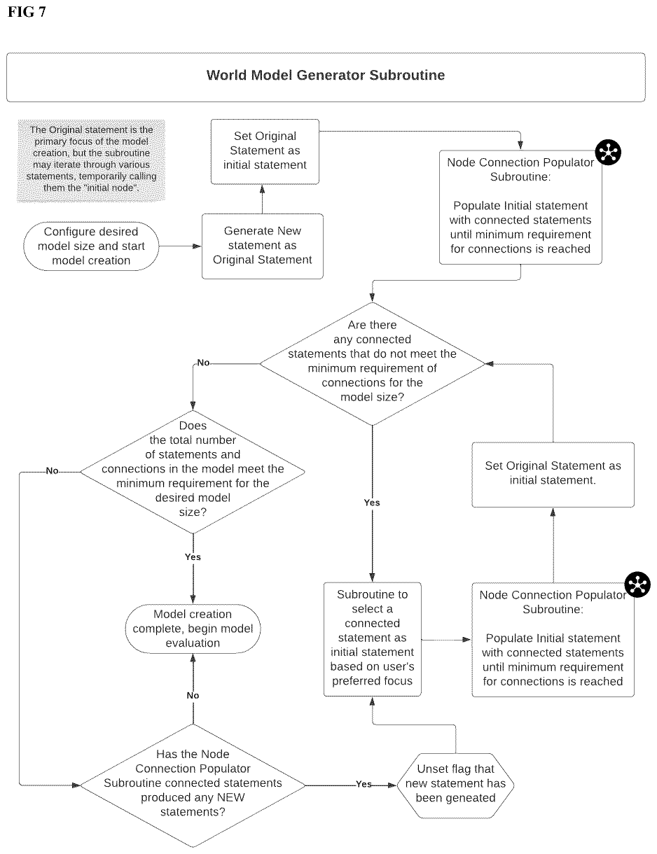

With this semantic ontology as a foundation to generate world models, an automated system [FIG. 7] can be created to populate a human-readable node network of any size.

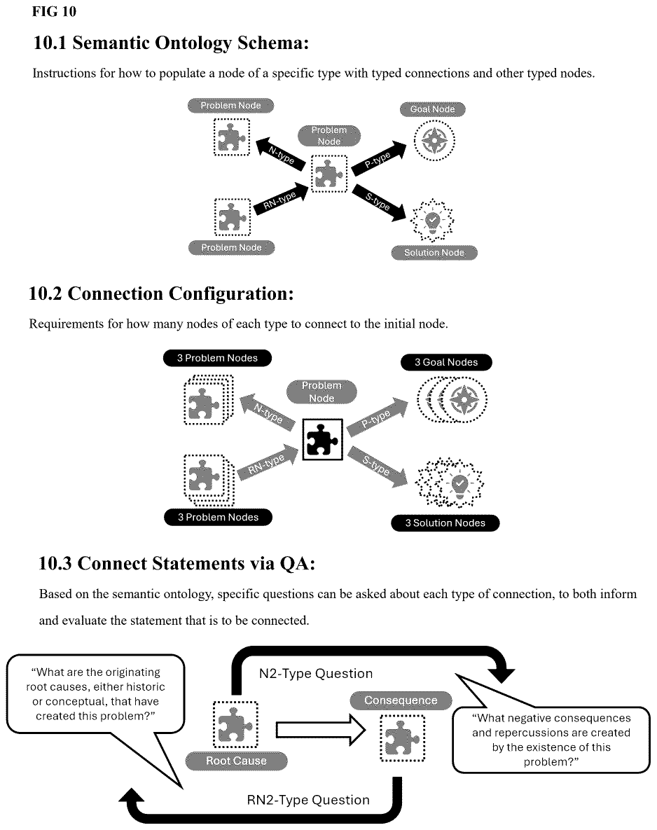

In essence, this world model generator subroutine is instructed to traverse the schematic blueprint of a node network, and repeatedly perform operations on each node, until a pre-defined limit has been reached. To illustrate this, FIG. 10 shows how a blueprint for a node network is provided as a Schema [10.1], and a Connection Configuration [10.2]. The Schema [10.1] prescribes which types of nodes connect to which types of connections, and the Connection Configuration [10.2] determines how many connections for each type of node or connection should be created.

It is important to distinguish between the schema (blueprint, architecture, or framework) of a node network and its connection types, and the actual content of populated connections. For example, a schema for a node network may be described as “one problem node with three goal nodes”, while the contents of this particular network may be described as “Problem Node: Lack of time. Goal Node 1: Abundant time. Goal Node 2: Space for leisure activities. Goal Node 3: Maximizing productivity”.

To begin populating a world model or node network, a user must submit an original statement or generate it automatically with a Large Language Model. The original statement is then treated as the initial statement for the following subroutines:

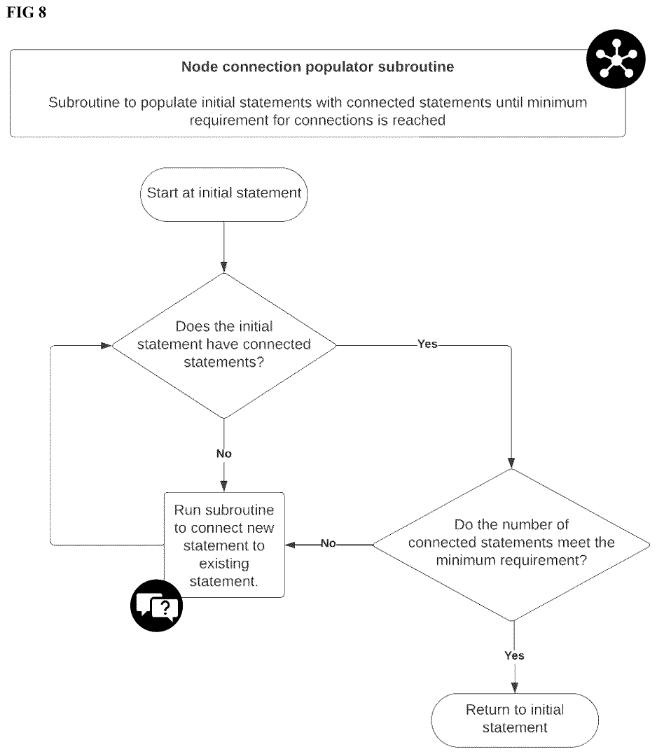

As a first step, the initial statement is populated with connected statements in a looping function until each type of connection has the minimum required number of connected statements attached to it [FIG. 8].

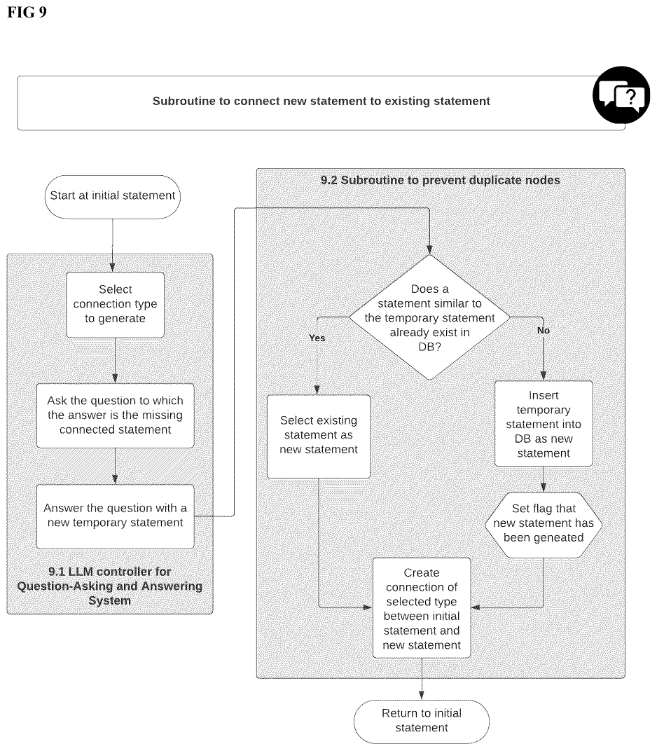

The looping function to populate a node is comprised of a question-asking subroutine that is responsible for the intelligent generation of statements [FIG. 9 and FIG. 3.3]. The question-asking subroutine can be created for each node connection type from the semantic ontology [sec FIG. 10.3].

Specifically, each type of connection can inform the structure of a predefined question. The answer to this question is necessarily a valid statement to complete the connection. Since every type of connection also has a reversed equivalent, another question can be formed to evaluate a connection or fill in a missing node. This means that the question-asking subroutine is capable of both generating the relevant questions that inform the creation of a new node, but it can also ask the questions that verify the validity of any given connection between nodes.

The question-asking subroutine is comprised of a controller [FIG. 2.72 and FIG. 9.1] that identifies the connection type and thus the question type, and a LLM which takes instructions from the controller for how to ask a question about a statement directed at the type of connection that needs a statement, according to the controller.

In detail, the question-asking LLM, abbreviated as QA, will be prompted by the controller as follows:

For a P-Type connection, the QA will be provided with the initial Goal Node and the statement which it contains, and then the QA will be instructed to write a question that asks what obstacles & challenges prevent this value goal from being achieved.

For an RP-Type connection, the QA will be provided with the initial Problem Node and the statement which it contains, and then the QA will be instructed to write a question that asks what are the violated needs, goals, and desired behind this problem.

For an S-Type connection, the QA will be provided with the initial Problem Node and the statement which it contains, and then the QA will be instructed to write a question that asks how this problem can be solved to overcome the root cause obstacle and fulfill the underlying need, desire, or requirement.

For an RS-type connection, the QA will be provided with the initial Solution Node and the statement which it contains, and then the QA will be instructed to write a question that asks what the problems are that this solution effectively addresses.

For a V-Type connection, the QA will be provided with the initial Goal Node and the statement which it contains, and then the QA will be instructed to write a question that asks how this goal can be achieved.

For an RV-Type connection, the QA will be provided with the initial Solution Node and the statement which it contains, and then the QA will be instructed to write a question that asks what needs, goals, and values this solution fulfills.

For a G-Type connection, the QA will be provided with the initial Goal Node and the statement which it contains, and then the QA will be instructed to write a question that asks what greater value encompasses this specific need.

For an RG-Type connection, the QA will be provided with the initial Goal Node and the statement which it contains, and then the QA will be instructed to write a question that asks what are the specific desires and requirements needed to attain this goal.

For an N1-Type connection, the QA will be provided with the initial Goal Node and the statement which it contains, and then the QA will be instructed to write a question that asks what negative consequences and repercussions are created by this value goal.

For an N2-Type connection, the QA will be provided with the initial Problem Node and the statement which it contains, and then the QA will be instructed to write a question that asks what negative consequences and repercussions are created by the existence of this problem.

Additionally, for an N2-Type connection, the QA will be provided with the initial Problem Node and the statement which it contains, and then the QA will be instructed to write a question that asks what smaller sub-problems this problem can be decomposed into.

For an N3-Type connection, the QA will be provided with the initial Solution Node and the statement which it contains, and then the QA will be instructed to write a question that asks what negative consequences and repercussions are created by this solution.

For an RN-Type connection, the QA will be provided with the initial Problem Node and the statement which it contains, and then the QA will be instructed to write a question that asks what the originating root causes are that have created this problem, either historic or conceptual. This question will work for all 3 RN-Types.

Additionally, for an RN2-Type connection, the QA will be provided with the initial Problem Node and the statement which it contains, and then the QA will be instructed to write a question that asks what the greater, more generalizable super-problem is, to which this problem is a sub-problem.

Once the QA LLM has received the initial node and the instructions for how to ask a question directed at a missing connection, another LLM will be used to generate the statement which constitutes the answer.

The entire reasoning system uses at least 3 pre-trained language models: One to generate Problem Descriptors, one to generate Goal Descriptors, and one to generate Solution Descriptors. These Descriptor Generators are also capable or parsing or converting statements into the correct format: Given the semantic ontology framework's requirements for how problem, goal, and solution statements should be worded (such as prescriptive or attitudinal propositions), the Descriptor Generators can take a given text and attempt to parse it into its equivalent problem, goal, or solution descriptors. This parsing process will be especially important when text-based or graph-based world models need to be evaluated according to the semantic ontology framework.

A controller subroutine [FIG. 2.72 and FIG. 9.1] is responsible for coordinating between the different LLMs and prompting the appropriate LLM when the connection in question calls for it, as dictated by the semantic ontology.

This question-answering subroutine, informed by the semantic ontology for the reasoning system is capable of producing knowledge in an unsupervised fashion, using Large Language Models [see FIG. 3]. The LLMs can be adjusted to fit the needs of the reasoning system. Sometimes a highly creative LLM that hallucinates a lot may be desired, other times an LLM that is less prone to hallucination may be preferred.

Additionally, a user can select a particular mode of focus before generating the model [see FIG. 4]. Based on this selected focus, the subroutine that selects the next connected statement as the initial statement for being populated may change. For example, if the user selects the “root cause analysis” mode, the system may select nodes with the fewest RN-Type connections as the next target, while a “outline detailed solution requirements” operation would prioritize G-Type and V-Type connections. On the other hand, a focus on “solution ideation & critique” would first populate S-Type and N3-Type connections, while a focus on “clarify repercussions, values, and motivations” would focus on N2-Type and P-Type connections first, before populating others.

To keep the automatically generated world-models self-consistent and manageable in size, an additional LLM-based control mechanism is implemented to double check newly generated statements for uniqueness [see FIG. 9.2]. If a similar statement already exists in the database of statements, then the node network is extended merely by reference. Instead of submitting the duplicate statement to the database, only a connection referencing the existing statements is added to the database. The same duplicate prevention mechanism can be used for the connections stored in the database.

After each node is populated with connected statements, the world-model generator subroutine [FIG. 7] will repeat the process for each connected node, until the desired size of world-model is achieved.

Several mechanisms can be incorporated into the system, to prevent it from looping forever, for example if the node populator subroutine has not actually produced any new statements, and only connected existing ones, the total size of the world-model may not grow. Therefore, in the case of an infinite loop, the reasoning system can be configured to abort world-model generation prematurely, even before the desired size is reached.

Once the world-model has finished generating, the user can browse or edit the contents as desired to extract valuable, useful, and meaningful knowledge that has been generated and share or communicate the knowledge and solutions that have been discovered [see FIG. 5 and FIG. 12].

The system is also capable of self-evaluation: A report-generating subroutine can convert the nodes of the world-model into plain text. From this plain text-version of the world-model, the statement generator LLMs can use parts of the world-model or the entire world-model as the input to generate new statements about the world-model or the connections created in the world-model, thus creating a further world-model about the world-model, from the same semantic ontology. Put simply, the knowledge-generation and solutions-discovery system can self-evaluate the knowledge and solutions that it has discovered, thereby creating a sort of artificial meta-cognition.

For example, the evaluation routine can retrieve all connections between nodes, and evaluate them one at a time, to verify that the cause-and-effect connection is plausible in both directions, and if not, the evaluator can flag the connection and create a problem node describing the discrepancy.

In the context of reasoning systems, this particular reasoning system thereby provides a mechanism for reflective reasoning and critical thinking. Specifically, this is achieved by feeding the knowledge that was generated by the reasoning system back into the reasoning system and configuring the system's architecture to identify and define problems. Due to the recursive nature of problem-solving, this reflective reasoning, critical thinking, and problem-solving process can be repeated indefinitely. However, after each cycle the knowledge that has been produced should be more refined than it was in the beginning. The ability to automate this process on a computer-implemented system should be useful in supporting users to solve multifaceted challenges with less cognitive effort.

Beyond the novel self-reflection mechanism, it is also possible to use more conventional ways to evaluate the world-model that was generated by the system. For example, those Solution Nodes with the fewest negative consequences but with the most problems solved and with the most value goals fulfilled can be ranked to the top of the network, and can be presented as “excellent, error free solutions”.

While ranking nodes based on the number of their connections is a well-known and understood technique, the ability to rank “good” solutions to the top further illustrates how the semantic ontology framework provides a meaningful categorization of knowledge that can quantify the effectiveness of any solution with respect to the problem it aims to solve.

Further, it is possible to save timestamped statistics and reports from each world-model in a database and display their development over time.

Other interesting features that can be automatically generated from the world-model are features such as unsolved but fundamental root cause problems, as well as loops that indicate circular logic within the model.

This illustrates how the system described herein can deliver quantifiable but also qualitative insights about the world model-based knowledge that it generates.

Returning to FIG. 3, the knowledge contained in the automatically generated world models [3.2] can be used to as a basis [3.8] to train or fine-tune [3.9] new language models [3.5] that are then specialized in this particular approach to problem-solving that has been described herein.

In summary, with the semantic ontology outlined, and the system for automatically populating the node network with statements and their connections using a clearly defined question-answer system, LLMs can be configured to produce a human-readable, self-consistent knowledge graph, and this knowledge graph can be evaluated and further developed in an unsupervised fashion, using LLMs.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The exemplary, preferred embodiment was chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

### Example 1

### Astrophysics, Gravity & Dark Matter

A scientist may be interested in getting to the bottom of the discrepancy behind the issue with galaxy rotation curves. At the time of this writing, astronomers have predicted one particular galaxy rotation curve but detected another. Consequently, a substance known as “dark matter” has been hypothesized, but such a substance has not yet been detected. The scientist using the reasoning system may submit this problem statement to the interface to ideate realistic solutions for how to detect dark matter, or the scientist may try to find ways to debunk the existence of dark matter altogether and analyze the true root cause of the discrepancy in galaxy rotation curves. While the reasoning system may not ultimately deliver the correct answer, it can help with ideation and ruling out bad ideas. Also, the knowledge provided by the system can be used to train new generations of LLMs [see FIGS. 3.2, 3.8, 3.9, and 3.5] and educate scientists in training, to better equip them on their quest of understanding and reverse engineering the cosmos.

### Example 2

### Fusion Reactors

An engineer may be interested in building a clean, sustainable method of producing energy, and has decided to look deeper into fusion reactors. Presently, a number of challenges are holding us back from building self-sustaining fusion reactors that produce more energy than was put in to start the fusion reaction. The engineer may use the system to critique their solution and clarify requirements for improved solutions. Since the reasoning system is human readable and can be modified by the engineer, the engineer can input connected statements in the system that were discovered during research in the real world. This real-world data can then be evaluated and contextualized by the system, to help with continued development and analysis, and accelerate the completion of a functioning clean energy device.

An example illustration of a tablet-based interface that the engineer may use to explore the world model and read or modify nodes is shown in FIG. 12. Additionally, FIG. 3.7 highlights how interfaces can be used to insert user-generated nodes into an otherwise automatically generated world model.

What is claimed is:

1. A computer-implemented knowledge-management system to automatically generate a node network-based world-model for reflective reasoning to develop meaningful knowledge about effective solutions to problems from a semantic ontology framework.

2. The semantic ontology framework from claim 1, comprised of a symbolic reasoning system with problem nodes U, goal nodes I, and solution nodes M, and their cause-and-effect based connections.

3. The symbolic reasoning system from claim 2, further comprising:
problem descriptors U which are descriptive statements with a negative judgement or attitudinal proposition to describe violated terminal goals, unfulfilled needs, unmet requirements, or unrealized expectations;
goal descriptors I which are normative or attitudinal statements with a positive judgement to describe aspirational and terminal goals, needs, idealistic values, expectations, requirements, or desires; and
solution descriptors M which are descriptive or prescriptive statements to explain instrumental goals, tangible and actionable processes, methods, or systems, or belief-based paradigms;
wherein I=˜U∧U=˜I and M:U→I and M→I⇔˜U.

4. The symbolic reasoning system from claim 2, further comprising reversible directed connections between problem nodes, goal nodes, and solution nodes that represent: obstacles U to goals I; unmet goals ˜I; fulfilled goals I; solved problems ˜U; solutions to problems M; greater goals I_{g}; specific needs Iₛ; sub-problems U_{c}; negative consequences U_{c}; repercussions U_{c}; root causes Uᵣₒₒₜ; and super-problems Uᵣₒₒₜ; wherein Uᵣₒₒₜ→U_{c}∧Uᵣₒₒₜ⊃U_{c} and I_{g}⊃Iₛ and I=˜U∧U=˜I and M:U→I and M→I⇔˜U and M→U and I→U.

5. The knowledge-management system from claim 1 further comprising a node connection populator subroutine to populate an initial node with connected nodes of each connection type according to the semantic ontology framework, the node connection populator storing nodes and connections on a computer and repeating itself until a user-configured number of nodes and connections has been reached.

6. The node connection populator subroutine from claim 5, further comprising a question-asking system following the semantic ontology framework, the question-asking system to generate a question to which the answer is a node to be populated by the node connection populator subroutine.

7. The question-asking system from claim 6, further comprising a controller subroutine informed by the semantic ontology framework, the controller subroutine first traversing the node network and selecting an initial node and a connection type with a missing connected statement, and then generating a question according to the node and connection type selected, whereby the answer to the generated question comprises the missing statement that completes the selected connection type.

8. The knowledge-management system from claim 1, further comprising a world-model evaluator subroutine evaluating a graph-based source model or a text-based source model to draw quantifiable and qualitative inferences by automatically generating a new world-model from the source model, the world-model evaluator subroutine further comprising: the semantic ontology framework;
a node connection populator subroutine to populate an initial node with connected nodes of each connection type according to the semantic ontology framework, the node connection populator storing nodes and connections on a computer and repeating itself until a user-configured number of nodes and connections has been reached; and
a question-asking system following the semantic ontology framework, the question-asking system to generate a question to which the answer is a node to be populated by the node connection populator subroutine.

9. An automated question-asking system informed by a semantic ontology framework, the question-asking generating a question about a statement or a cause-and-effect based connection that is meaningful according to the semantic ontology framework.

10. The semantic ontology framework from claim 9, further comprising:
problem descriptors U which are descriptive statements with a negative judgement or attitudinal proposition to describe violated terminal goals, unfulfilled needs, unmet requirements, or unrealized expectations;
goal descriptors I which are normative or attitudinal statements with a positive judgement to describe aspirational and terminal goals, needs, idealistic values, expectations, requirements, or desires; and
solution descriptors M which are descriptive or prescriptive statements to explain instrumental goals, tangible and actionable processes, methods, or systems, or belief-based paradigms;
wherein I=˜U∧U=˜I and M:U→I and M→I⇔˜U.

11. The semantic ontology framework from claim 9, further comprising reversible directed connections between problem nodes, goal nodes, and solution nodes that represent: obstacles U to goals I; unmet goals ˜I; fulfilled goals I; solved problems ˜U; solutions to problems M; greater goals I_{g}; specific needs Iₛ; sub-problems U_{c}; negative consequences U_{c}; repercussions U_{c}; root causes Uᵣₒₒₜ; and super-problems Uᵣₒₒₜ; wherein Uᵣₒₒₜ→U_{c}∧Uᵣₒₒₜ⊃U_{c} and I_{g}⊃Iₛ and I=˜U∧U=˜I and M:U→I and M→I⇔>˜U and M→U and I→U.

12. The question-asking system from claim 9, further comprising a controller subroutine to answer the generated question in a format that is meaningful to the semantic ontology framework from claim 9, and then storing the answer in a computer-implemented node network with an architectural schema informed by the semantic ontology framework from claim 9.

13. A world-model evaluator system informed by a semantic ontology framework evaluating a graph-based source model or a text-based source model to draw quantifiable and qualitative inferences by automatically generating a new world-model from the source model, the new world-model following the semantic ontology framework.

14. The semantic ontology framework from claim 13, further comprising:
problem descriptors U which are descriptive statements with a negative judgement or attitudinal proposition to describe violated terminal goals, unfulfilled needs, unmet requirements, or unrealized expectations;
goal descriptors I which are normative or attitudinal statements with a positive judgement to describe aspirational and terminal goals, needs, idealistic values, expectations, requirements, or desires; and
solution descriptors M which are descriptive or prescriptive statements to explain instrumental goals, tangible and actionable processes, methods, or systems, or belief-based paradigms;
wherein I=˜U∧U=˜I and M:U→I and M→I⇔˜U.

15. The semantic ontology framework from claim 13, further comprising reversible directed connections between problem nodes, goal nodes, and solution nodes that represent: obstacles U to goals I; unmet goals ˜I; fulfilled goals I; solved problems ˜U; solutions to problems M; greater goals I_{g}; specific needs Iₛ; sub-problems U_{c}; negative consequences U_{c}; repercussions U_{c}; root causes Uᵣₒₒₜ; and super-problems Uᵣₒₒₜ;
wherein Uᵣₒₒₜ→U_{c}∧Uᵣₒₒₜ⊃U_{c} and I_{g}⊃Iₛ and I=˜U∧U=˜I and M:U→I and M→I⇔˜U and M→U and I→U.

16. The world-model evaluator system from claim 13, further comprising a statement-parsing controller that converts a source model into an equivalent node network of problem descriptor nodes, goal descriptor nodes, or solution descriptor nodes according to the semantic ontology framework.

17. The world-model evaluator system from claim 13, further comprising a controller subroutine informed by the semantic ontology framework, the controller subroutine traversing the node network and selecting an initial node and a connection type with a missing connected statement.

18. The controller subroutine from claim 17, further comprising a question-asking system following the semantic ontology framework, the question-asking system to generate a question according to the node and connection type selected by the controller subroutine, whereby the answer to the generated question comprises the missing statement that completes the selected connection type.

19. The world-model evaluator system from claim 13 further comprising a node connection populator subroutine to populate an initial node with connected nodes of each connection type according to the semantic ontology framework, the node connection populator subroutine storing nodes and connections on a computer and repeating itself until a user-configured number of nodes and connections has been reached, wherein the nodes and connections created represent reasoning about the source model to be evaluated.
